(19) United States
(12) Patent Application Publication
(10) Pub. No.: US 2008/0302994 A1
(43) Pub. Date: Dec. 11, 2008

(54) Modular Rotary Union

(75) Inventor: Gerald D. Syzkulski, Ham Lake, MN (US)

Correspondence Address: Gerald Szykulski;Rotary Systems, Inc., 14440 Azurite Street, NW, Ramsey, MN, 55303, US

(73) Assignee: Rotary Systems, Inc., Ramsey, MN (US)

(21) Appl. No.: 11/760,735

(22) Filed: Jun. 9, 2007

(51) Int. Cl. F16K 31/12

(52) U.S. Cl. 251/345

(57) ABSTRACT

A modular rotary union and method of fabricating the same. The modular rotary union includes a housing and a rotor. The rotor includes a shaft portion rotatably supported in an axial bore of the housing. The rotor further includes a head portion secured to one end of said shaft portion. The shaft portion is selected from a quantity of shafts of a predetermined size and of a predetermined number of ports machined from a first quantity of material. The head portion is selected from a quantity of heads of a predetermined type, size, number of ports and port type machined from a second quantity of material.

### CROSS REFERENCE TO RELATED APPLICATIONS

This application claims priority to U.S. Provisional Application No. 60/804,208 Filed Jun. 8, 2006, which is incorporated herein in its entirety.

### BACKGROUND

Rotary unions or rotating unions are used in applications where it is necessary to communicate fluid between stationary and rotating components of a machine or device or between relatively rotating components of a machine or device.

A typical rotary union includes a housing and a rotor. The housing generally includes an axial bore and one or more ports that are open at one end to the exterior of the housing and open at the other end to the axial bore. The rotor includes a shaft portion that rotates within the axial bore of the housing. The other end of the shaft portion typically includes a coaxial head portion that extends a distance from the end of the housing and secures or couples to the rotating component of the machine or device being served by the rotary union. One or more fluid passages in the rotor communicate fluid to the respective ports in the housing.

Rotary unions vary considerably in sizes, types of fluids (liquids and gases) communicated, fluid pressures, relative rotational velocities and the number of ports. In addition, there are several fluid coupling conventions that govern the manner of coupling the ports and passages to the fluid lines and components of the machines or devices being served by the rotary unions. For example, depending on the application, the ports and passages may need to be tapped and threaded according to NPT (National Pipe Taper) standards, SAE (Society of Automotive Engineers) standards, BSP (British Standard Pipethread) standards, ISO, etc. Furthermore, the type of thread standards may vary between different ports in the housing or between different passages in the rotor.

Furthermore, the type of rotor connection may vary. For example, some rotors may incorporate a flanged head for bolting to a mating flange on the rotating component of the machine or device being served. Other types of rotors may incorporate a slip ring for accommodating an electrical connection between electrical elements on the rotating component and electrical elements on the stationary component of the machine or device being served by the rotary union. Still other rotors may couple with a shaft extension or the particular application may require an end cap or other feature.

Accordingly, it is not practical to stock a quantity of rotary unions of various ports, port sizes, port types, head types, etc. However, there is a need for a system and method for suppliers to reduce lead time needed to deliver rotary unions to meet customer needs.

Apart from the inefficiencies associated with stocking multiple rotary unions of various sizes, different numbers of passages, different thread standard types, and different types of rotor couplings, etc., there are often problems associated with the conventional manner of manufacturing the rotors used in rotary unions. Typically, rotors are machined from a single piece of metal using a turning lathe machine. For rotors that include a larger diameter flanged head, the flanged head and shaft of the rotor are usually machined from the same metal piece such that they are integrally formed. Thus, the finish diameter of the flanged head dictates the size of the metal piece from which the rotor is machined. As such, it should be appreciated that depending on the difference in outside diameters between the shaft and the head, the amount of machining required to reduce the metal piece to a finished rotor may be substantial. The more machining required, the higher the labor costs will be and the higher will be the costs associated with tool wear and maintenance. Additionally, material costs will necessarily be higher because larger diameter metal pieces must be purchased from which the head and shaft are machined as a single integral rotor.

Related to the foregoing, for rotors with flange heads, because the flange head is typically larger in diameter relatively thin in comparison to the length of the shaft, the flanged head and shaft portion generally gain and lose heat at different rates during the heat treatment process. Similarly, with cylindrical heads, due to the differences in mass of the head compared to the shaft, heat gain and loss occurs at different rates. This difference in heat loss often results in distortions in the flatness and/or roundness of the flanged head or with respect to the shaft, thereby requiring further machining operations or other measures to correct the distortions or to minimize the occurrence of distortions. While some distortions can be ignored in many applications, in other applications where greater precision is required due to high rotational speeds or other tight tolerance requirements, such distortions are not acceptable.

Thus, there is a need for an improved system and method for producing rotors which overcomes the increased labor, maintenance and material costs associated with machining the shaft and flanged heads from a single piece, while also eliminating or reducing the occurrence of distortions of the head and/or of the head with respect to the shaft.

### DESCRIPTION OF THE DRAWINGS

FIG. 1 is an exploded perspective view of a conventional four-port rotary union.

FIG. 2 is an exploded cross-sectional view of the conventional four-port rotary union of FIG. 1 as viewed along lines 2-2 of FIG. 1 showing the integral rotor 16 construction.

FIG. 3 is an assembled cross-sectional view of the conventional four-port rotary union of FIG. 2.

FIG. 4 is an exploded perspective view of one embodiment of the modular rotary union of the present invention which is otherwise substantially the same as the rotary union of FIG. 1 except for its modular rotor construction.

FIG. 5 is an exploded cross-sectional view of the modular rotary union of FIG. 4 as viewed along lines 5-5 of FIG. 4 showing the modular rotor construction.

FIG. 6 is an assembled cross-sectional view of the modular rotary union of FIG. 5.

FIG. 7 is a side elevation view of another embodiment of the modular rotary union of the present invention, also with four ports, and also showing the modular rotor, but with a flange head and with other conventional rotary union components.

### DETAILED DESCRIPTION

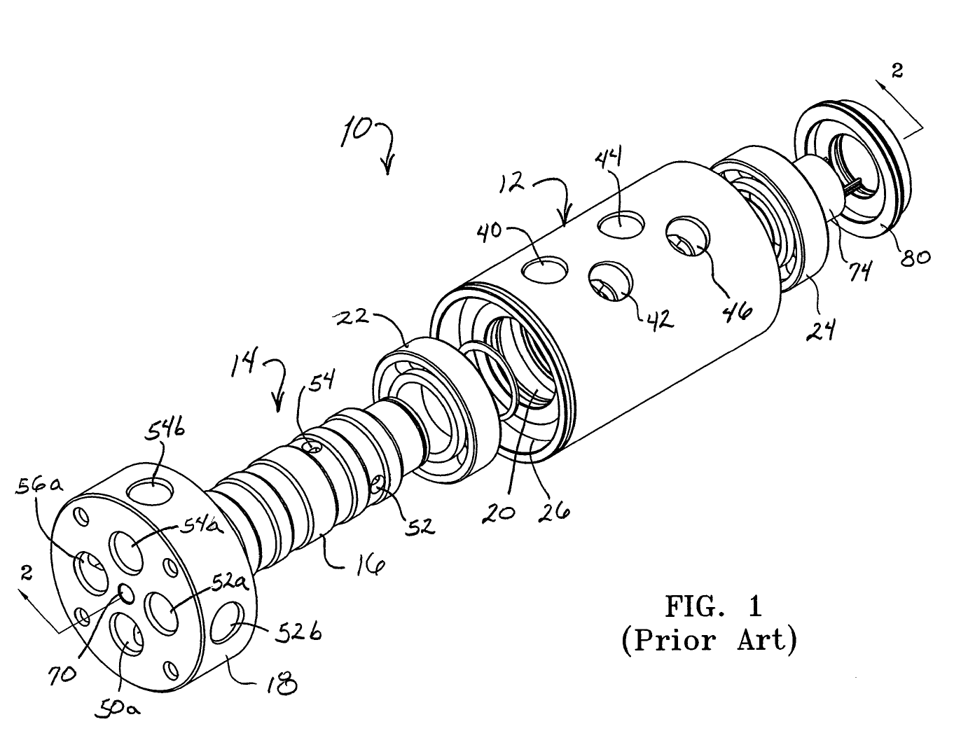

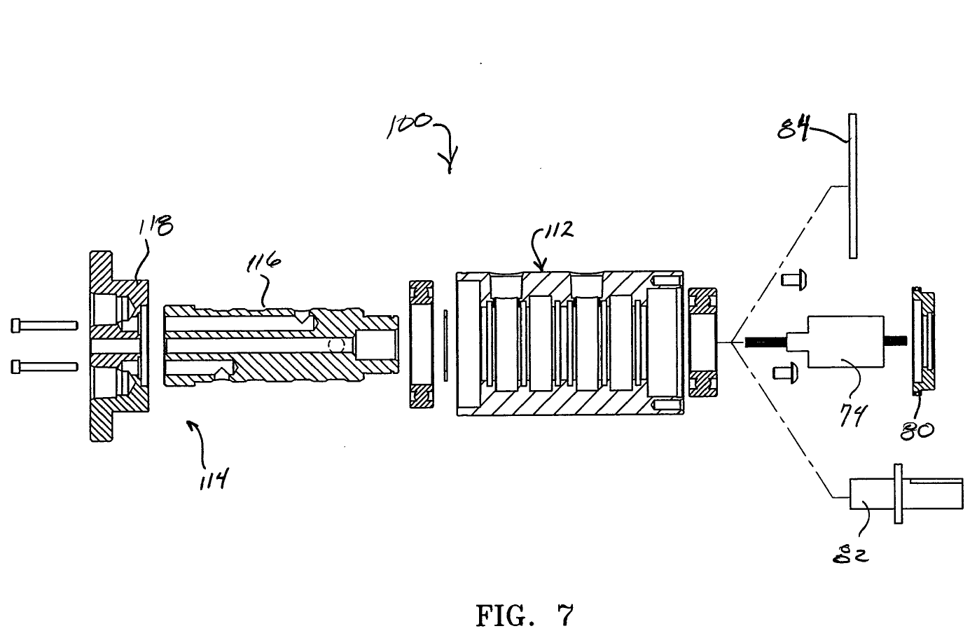

Referring now to the drawings, wherein like reference numerals designate identical or corresponding parts throughout the several views, FIGS. 1-3 illustrate a conventional four-port rotary union 10. It being understood that rotary unions may vary in size (length and diameter), number of ports (from one to twenty or more), port type (NTP, SAE, BSP, ISO, etc.), port size and head type, such as an NTP head as illustrated in FIGS. 1-3 or a flanged head as illustrated in FIG. 7. Accordingly, the four-port rotary union with NTP head illustrated in FIGS. 1-3 is provided only as an example of a typical conventional rotary union.

Also as is conventional, the four-port rotary union 10 depicted in FIG. 1 comprises a housing 12 and a rotor 14. Rotors for rotary unions are typically machined from a single billet or a single piece of bar stock using a turning lathe machine thereby producing a rotor with an integral shaft portion 16 and head portion 18 as illustrated in FIGS. 1-3. The shaft portion 16 of the rotor 14 is rotatably supported within an axial bore 20 in the housing 12 by a pair of bearing assemblies 22, 24 which are seated within annular bearing recesses 26, 28 disposed coaxial with the annular bore 20 at each end of the housing 12.

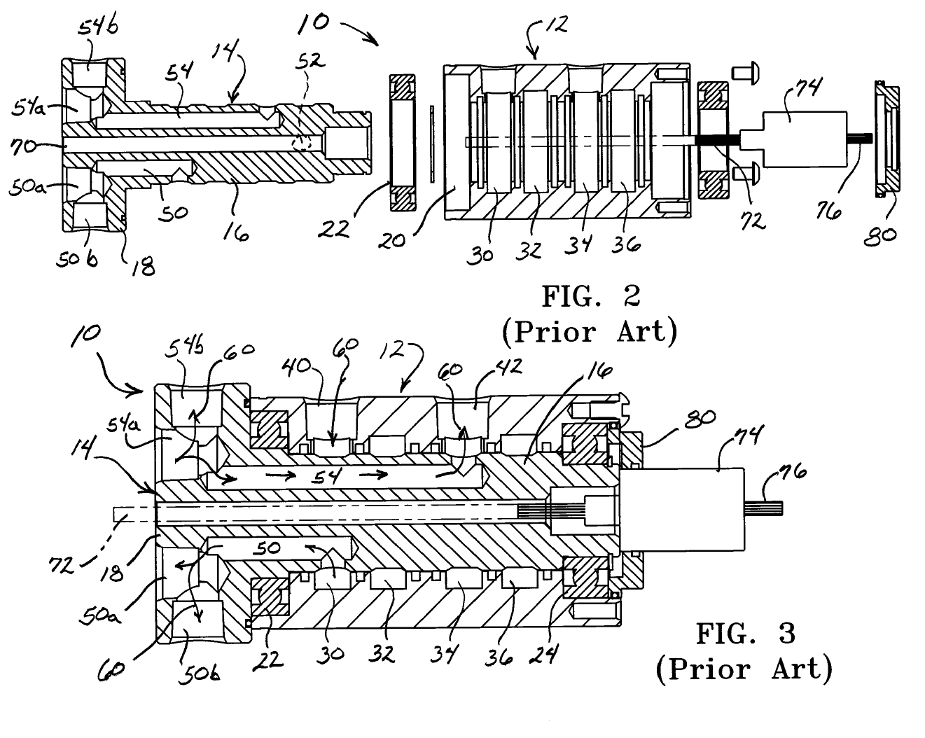

The housing 12 includes four axially spaced annular recesses 30, 32, 34, 36 each of which is open to the exterior of the housing by a corresponding port 40, 42, 44, 46. The ports in the housing are typically radially offset to provide sufficient clearance for connecting lines or tubes (not shown) which convey the fluid to or from the rotary union. The rotor 14 likewise includes four separate passages 50, 52, 54, 56 open at the head 18 and at points along the shaft 16 that correspond to one of the annular recesses 30, 32, 34, 36. It should be noted that passage 52 is not visible in FIGS. 2 and 3 because it is disposed behind the through-bore 70 (discussed later). Similarly, passage 56 is not visible in FIGS. 2 and 3 because it is disposed in the cut-away portion of the rotor 14. In the embodiment of the rotary union 10, the passages 50, 52, 54, 56 through the head 18 open into a set of ports (50a, 50b; 52a, 52b; 54a, 54b; 56a, 56b, respectively) one of the ports from each set serving as a bypass port for excess fluid. If a flanged head were provided (as in FIG. 7), each passage 50, 52, 54, 56 would open into a single port 50a, 52a, 54a, 56a.

In operation, as the rotor 14 rotates within the housing 12, and as indicated by arrows 60 in FIG. 3, fluid is communicated via tubes or lines (not shown) through the ports 30, 32, 34, 36 and through the rotating rotor 14 through the passages 50, 52, 54, 56 open to the annular recesses 20, 22, 24, 26. Thus, fluid is communicated to and from the stationary element (i.e. the housing 12) of the rotary union 10 to and from the rotating element (i.e., the rotor 14).

Also as is conventional, FIGS. 1-3 depict that the rotor 14 includes a central through-bore 70 through which electrical wires 72 may pass. To prevent the wires 72 from twisting as the rotor 14 rotates, a conventional slip ring 74 is provided which permits the wires 72 to rotate with the rotor 14 relative to the stationary wires 76 leading into the slip ring 74.

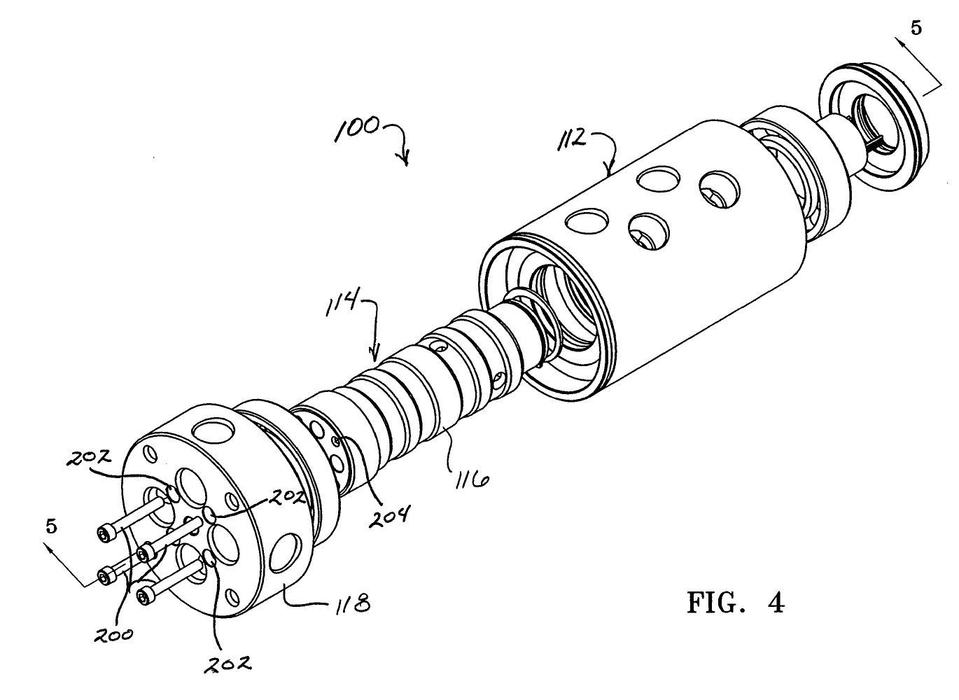

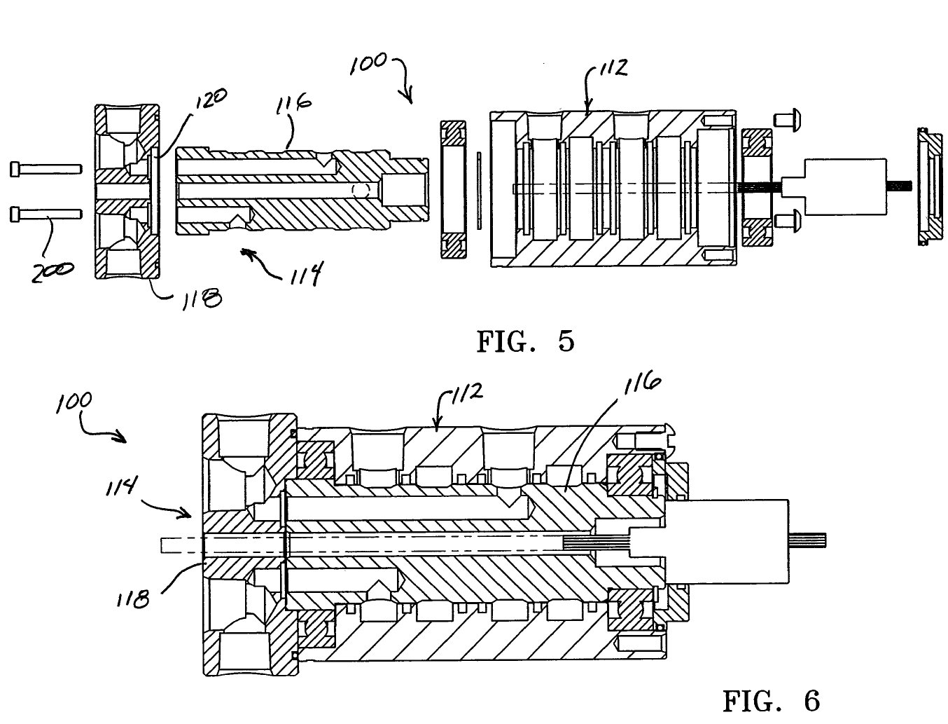

Turning now to FIGS. 4-6 one embodiment of a rotary union 100 of modular construction in accordance with the present invention is illustrated. As with the conventional rotary union 10 illustrated in FIGS. 1-3, the modular rotary union 100 of the present invention includes a housing 112 and a rotor 114. Likewise, as with the conventional rotor 14, the rotor 114 comprising the present invention includes a shaft portion 116 and a head portion 118. However, unlike the conventional rotor, the head 118 and shaft 116 of the rotor 114 are of modular construction, in that they are separately fabricated, thereby enabling different heads 118 to be interchangeable with different shafts 116. For example, instead of a cylindrical NTP head as illustrated in FIGS. 4-6 a flanged head as illustrated in FIG. 7 may be secured to the modular shaft 116. Alternatively a head with different port thread standards (i.e., SAE, BSP, ISO, etc.) may be used, etc. It should be appreciated that other than the modular rotor construction, upon assembly, the modular rotary union 100 comprises substantially the same elements and functions identically to the conventional rotary union 10.

With a modular rotor, to ensure coaxial alignment of the modular heads 118 and shafts 116, the modular heads 118 preferably include a recess 120 into which the modular shaft 116 is press fit. To facilitate alignment of the passages 50, 52, 54, 56 in the modular heads and shafts and to ensure that the heads and shafts are securely fixed together, the two parts may be fastened by threaded connectors 200 extend through apertures 202 in the head 118 and are threadably received into threaded apertures 204 (FIG. 4) in the shaft 116. Alternatively or in addition to threaded connectors, the shafts and heads may be welded together after press fitting or the heads and shafts may be threaded together. Depending on the materials used for the modular heads and shafts, other means of fixedly securing the parts together may be suitable, including, for example, adhesives or other boding agents, ultrasonic welding, heating, or any other suitable means as recognized by those of skill in the art.

To ensure a fluid tight connection between the passages 50, 52, 54, 56 of the modular head 118 which mate with the passages 50, 52, 54, 56 in the modular shaft 116, small annular recesses 204 are preferably machined into the face of the modular head 118 to receive an o-ring seal (not shown) of suitable material for the fluid with which the rotary union 100 is to be used. As previously identified, once the modular heads 118 and modular shafts 116 are secured together, the rest of the elements comprising the modular rotary union 100 and the manner of assembling those elements are substantially the same as a conventional rotary union assembly as previously discussed. Additionally, as with a conventional rotary union, the material used for the housing 112 and modular rotor 114 comprising the modular rotary union 100 may be of any material suitable for the type of fluids, pressures, tolerances, and environments with which the rotary union is to be used, including, for example, steel, aluminum, brass, and various other metal alloys, various types of plastics, composites, etc.

As previously discussed, an advantage that the modular rotary union 100 has over the conventional rotary union, is that the head 118 and shaft 116 are interchangeable. For example, instead of a cylindrical NTP head as illustrated in FIGS. 4-6 a flanged head as illustrated in FIG. 7 may be secured to the modular shaft 116. Alternatively a head with different port thread standards (i.e., SAE, BSP, ISO, etc.) may be used, etc. Also as illustrated in FIG. 7, other conventional components may be used when assembling the rotary union. For example, rather than the slip-ring 74 and bearing cover 80, a conventional shaft extension 82 of any desired length may be coupled to the shaft 16. Alternatively, an end cap 84 may be secured over the end of the housing. Other known attachments may also be incorporated when assembling the modular rotary union 100.

As noted above, one of the advantages of modular construction is that it enables a supplier (manufacturer or distributor) to maintain an inventory of parts that are interchangeable and therefore the supplier is more likely to be able to more efficiently meet the needs of its customers. Rather than fabricating and stocking complete rotors, the supplier is able to stock a quantity of shafts that are interchangeable with a variety of different heads, whether flanged heads or cylindrical heads of various port types.

An added benefit of fabricating heads and shafts separately as opposed to machining the rotors as an integral unit from a single billet or bar stock is that it reduces material waste. Since the shafts are generally smaller in diameter than the heads, smaller diameter bar stock may be used to machine the shafts. The larger diameter bar stock required for the heads can be used to machine multiple heads from material that would otherwise be machined away for the shafts. Furthermore efficiencies in labor can be gained through less machining time, since less material will need to be machined to produce the shafts separately from the heads. Additionally, efficiencies in labor and precision may be achieved by the machinists being able to produce identical heads multiple times and identical shafts multiple times. Also, with less machining time required to produce the same number of rotors, the fabrication costs will be reduced due to less tool wear and maintenance requirements.

With modular rotor construction, because the heads can shafts can be separately heat treated, there is less distortion during heat treatment due to the fact that the pieces are of a more uniform diameter and mass. Thus, providing head/shaft assemblies in lieu of one-piece rotors allows higher precision manufacturing of components, resulting in rotary unions that comply with tighter tolerances and therefore meet higher performance standards.

It should be appreciated that although the modular rotary union 100 of the present invention is shown and described as a four-port rotary union, the rotary union 100 may comprise any number of ports, and may be of any size and length. Additionally, as previously identified, the heads may be of any type and the ports may be of any size and type. As such it should be understood that the foregoing description is presented to enable one of ordinary skill in the art to make and use the invention and is provided in the context of a patent application and its requirements. Various modifications to the preferred embodiment of the apparatus and the general principles and features described herein will be readily apparent to those of skill in the art. Thus, the present invention is not to be limited to the embodiments of the apparatus and methods described above and illustrated in the drawing figures, but is to be accorded the widest scope consistent with the spirit and scope of the appended claims.

1. A modular rotary union, comprising:
a housing;
a rotor having a shaft portion rotatably supported in an axial bore of said housing, said rotor further having and a head portion secured to one end of said shaft portion;
said shaft portion selected from a quantity of shafts of a predetermined size and of a predetermined number of ports machined from a first quantity of material;
said head portion selected from a quantity of heads of a predetermined type, size, number of ports and port type machined from a second quantity of material.

2. A method of fabricating a modular rotary union having a housing and a rotor, said method comprising:
machining a quantity of shafts of a predetermined size and for a predetermined number of ports from a first quantity of material;
machining a quantity of heads of a predetermined type, size, number of ports and port type from a second quantity of material;
selecting one of said machined shafts and one of said quantity of machined heads;
securing said selected machined shaft to said selected machined head to form a rotor;
rotatably supporting a portion of a shaft portion of said rotor in an axial bore in the housing.

3. The modular rotary union of claim 1, wherein said head portion includes a recess for receiving said shaft portion.

4. The method of claim 2, further including the step of forming a recess in said head to receive said shaft.

5. The modular rotary union of claim 3, wherein said head portion is secured to said shaft portion by threaded connectors.

6. The modular rotary union of claim 3, wherein said head portion is secured to said shaft portion by a welded connection.

7. The modular rotary union of claim 3, wherein said head portion is secured to said shaft portion by a threaded connection.

8. The method of claim 4, wherein said step of securing said selected machined shaft to said selected machined head includes securing said shaft and said head together using threaded connectors.

9. The method of claim 4, wherein said step of securing said selected machined shaft to said selected machined head includes securing said shaft and said head together by a welded connection.

10. The method of claim 4, wherein said step of securing said selected machined shaft to said selected machined head includes securing said shaft and said head together by a threaded connection.
